(19) United States
(12) Patent Application Publication
(10) Pub. No.: US 2025/0175563 A1
(43) Pub. Date: May 29, 2025

(54) MEDIUM FEEDING DEVICE AND IMAGE READING APPARATUS

(71) Applicant: SEIKO EPSON CORPORATION, Tokyo (JP)

(72) Inventors: Kendai KAWAKAMI, KITAKYUSHU-SHI (JP); Masaki NAMIKI, KITAKYUSHU-SHI (JP)

(21) Appl. No.: 18/960,862

(22) Filed: Nov. 26, 2024

(30) Foreign Application Priority Data
Nov. 27, 2023 (JP) 2023-199659

(51) Int. Cl. H04N 1/00

(52) U.S. Cl. CPC H04N 1/00588; H04N 1/00538; H04N 1/00543; H04N 1/00602; H04N 1/00628

(57) ABSTRACT

A medium feeding device includes a medium support section configured to support a medium, a feeding section configured to feed a medium from the medium support section, a driving power source for the feeding section, a switching section configured to perform switching between a state in which a driving force is transmitted from the driving power source to the feeding section and a state in which a driving force is not transmitted, and a feeding unit being a unit configured to accommodate the feeding section and the switching section and be removably mounted on a unit mounting section, wherein the switching section is removably mounted on the feeding unit.

The present application is based on, and claims priority from JP Application Serial Number 2023-199659, filed Nov. 27, 2023, the disclosure of which is hereby incorporated by reference herein in its entirety.

### BACKGROUND

### 1. Technical Field

The present disclosure relates to a medium feeding device that feeds a medium, and an image reading apparatus including the medium feeding device.

### 2. Related Art

JP-A-5-134495 proposes a document feeding device in which functional components relating to document feeding can collectively be replaced by integrating rollers and the functional components associated therewith.

A switching means is capable of performing switching between a state in which a driving force is transmitted to a roller and a state in which a driving force is not transmitted thereto, and is a consumable item that requires replacement in some cases. However, the configuration described in JP-A-5-134495 does not consider this point at all.

### SUMMARY

In order to solve the above-mentioned problem a medium feeding device according to the present disclosure is a medium feeding device configured to feed a medium includes a medium support section configured to support a medium, a feeding section configured to feed a medium from the medium support section, a driving power source for the feeding section, a switching section configured to perform switching between a state in which a driving force is transmitted from the driving power source to the feeding section and a state in which a driving force is not transmitted, and a feeding unit being a unit configured to accommodate the feeding section and the switching section and being removably mounted on a unit mounting section, wherein the switching section is removably mounted on the feeding unit.

Further, an image reading apparatus according to the present disclosure includes the medium feeding device and a reading unit configured to read a medium fed by the medium feeding device.

### BRIEF DESCRIPTION OF THE DRAWINGS

FIG. 1 is a view illustrating a medium transport path in an image reading apparatus.

FIG. 2 is an outer perspective view of the image reading apparatus when an opening/closing unit is closed.

FIG. 3 is an outer perspective view of the image reading apparatus when the opening/closing unit is opened.

FIG. 4 is a perspective view of a unit mounting section when a cover is mounted.

FIG. 5 is a perspective view of the unit mounting section when the cover is removed and a feeding unit is mounted.

FIG. 6 is a perspective view of the feeding unit.

FIG. 7 is a perspective view of the unit mounting section when the cover and the feeding unit are removed.

FIG. 8 is a perspective view of a feeding unit according to another embodiment.

FIG. 9 is a plan view of a feeding unit according to another embodiment.

FIG. 10 is a perspective view of a feeding unit according to another embodiment.

FIG. 11 is a perspective view of a feeding unit and a unit mounting section according to another embodiment.

### DESCRIPTION OF EMBODIMENTS

Hereinafter, the present disclosure is schematically described.

A medium feeding device according to a first aspect is a medium feeding device configured to feed a medium, including a medium support section configured to support a medium, a feeding section configured to feed a medium from the medium support section, a driving power source for the feeding section, a switching section configured to perform switching between a state in which a driving force is transmitted from the driving power source to the feeding section and a state in which a driving force is not transmitted, and a feeding unit being a unit configured to accommodate the feeding section and the switching section and being removably mounted on a unit mounting section, wherein the switching section is removably mounted on the feeding unit.

According to the present aspect, the medium feeding device includes the feeding unit being a unit including the feeding section and the switching section and being removably mounted on the medium feeding device, and the switching section is removably mounted on the feeding unit. With this, when there is a need for replacement of the switching section, maintenance, or the like, such work can easily be executed. In particular, the feeding unit is removed from the unit mounting section, and then the switching section is removed from the feeding unit. With this, the switching section can be removed with further facilitated workability.

In a second aspect, which is an aspect dependent on the first aspect, the feeding unit includes an accommodation member configured to accommodate the feeding section and the switching section, and the switching section is removably mounted on the accommodation member.

According to the present aspect, the feeding unit includes an accommodation member configured to accommodate the feeding section and the switching section, and the switching section is removably mounted on the accommodation member. Thus, handling of the feeding unit is facilitated.

In a third aspect, which is an aspect dependent on the second aspect, the feeding section includes a pick roller configured to send out a medium from the medium support section, and a feeding roller being positioned downstream in a medium feeding direction with respect to the pick roller and being configured to further feed a medium further downstream, and a roller unit including the pick roller and the feeding roller is removably mounted on the feeding unit.

According to the present aspect, the feeding section includes the pick roller and the feeding roller, and the roller unit including the pick roller and the feeding roller is removably mounted on the feeding unit. Thus, when there is a need for replacement of the feeding section, maintenance, or the like, such work can easily be executed. In particular, the feeding unit is removed from the unit mounting section, and then the roller unit is removed from the feeding unit. With this, the roller unit can be removed with further facilitated workability.

Note that the present aspect may depend not only on the second aspect described above but also on the first aspect described above.

In a fourth aspect, which is an aspect dependent on the third aspect, each of the pick roller and the feeding roller is removably mounted on the roller unit. According to the present aspect, each of the pick roller and the feeding roller is removably mounted on the roller unit. Thus, only one of the pick roller or the feeding roller can be replaced, and usability of the device is improved.

In a fifth aspect, which is an aspect dependent on the third aspect, at least one of the switching section or the roller unit is provided with a detected section, and the unit mounting section includes a detecting section configured to detect the detected section when the feeding unit is mounted.

According to the present aspect, at least one of the switching section or the roller unit is provided with the detected section, and the unit mounting section includes the detecting section configured to detect the detected section when the feeding unit is mounted. Thus, it can be detected that the feeding unit is mounted while the switching section or the roller unit is forgotten to be mounted on the feeding unit. As a result, the medium can be fed as appropriate.

Note that the present aspect may depend not only on the third aspect described above but also on the fourth aspect described above.

A sixth aspect, which is an aspect dependent on the fifth aspect, includes a display section configured to display various types of information, and a control section configured to receive detection information from the detecting section and control the display section, wherein the control section suspends feeding of a medium and displays an alert on the display section when a feeding instruction is received while the detected section is not detected, based on detection information from the detecting section.

According to the present aspect, the control section suspends feeding of a medium and displays an alert on the display section when a feeding instruction is received while the detected section is not detected, based on detection information from the detecting section. Thus, a user can be notified that the switching section or the roller unit is not mounted. As a result, usability of the device is improved.

A seventh aspect, which is an aspect dependent on the third aspect, includes a device main body including the driving power source, and an opening/closing unit being a unit configured to be opened and closed with respect to the device main body, opening/closing unit forming a part of a transport path for transporting a medium by being closed, and releasing a part of the transport path by being opened, wherein the unit mounting section is provided to the opening/closing unit, and the device main body includes a separation roller configured to nip a medium with the feeding roller and separate the medium.

According to the present aspect, the opening/closing unit configured to be opened and closed with respect to the device main body is included, the unit mounting section is provided to the opening/closing unit, and the device main body includes the separation roller configured to nip a medium with the feeding roller and separate the medium. In such a configuration the operational effects of the third aspect described above are obtained.

Note that the present aspect may depend not only on the third aspect described above but also on any one of the fourth to sixth aspects described above.

An image reading apparatus according to an eighth aspect includes the medium feeding device according to any one of the first to seventh aspects and a reading unit configured to read a medium fed by the medium feeding device.

According to the present aspect, the operational effects of any one of the first to seventh aspects described above can be obtained in the image reading apparatus.

Hereinafter, the present disclosure is specifically described.

Note that an X-Y-Z coordinate system illustrated in each of the drawings is an orthogonal coordinate system in which an X-axis direction is a direction intersecting with a transport direction of a medium, in other words, a medium width direction, and is also a device width direction.

Further, a Y-axis direction is a device depth direction. A +Y direction of the Y-axis direction is a direction from a device back surface toward a device front surface, and a −Y direction is a direction from the device front surface toward the device back surface.

A Z-axis direction is a vertical direction, and is also a device height direction. A +Z direction of the Z-axis direction is an upward direction, and a −Z direction is a downward direction.

An image reading apparatus 1 of the present embodiment is a scanner capable of reading an image of a medium, and is a sheet-feed type scanner that reads an image of a medium while transporting the medium. Here, the image on the medium indicates one visually recorded on the medium, and is, for example, a character, a figure, a table, a picture, a photograph, or the like. The medium is not limited to a sheet, and also includes a card and a booklet.

Note that the image reading apparatus 1 may be referred to as the medium feeding device 2 in view of feeding a medium. In such a case, the image reading apparatus 1 includes the medium feeding device 2, and a first reading section 25 and a second reading section 26, which are described later.

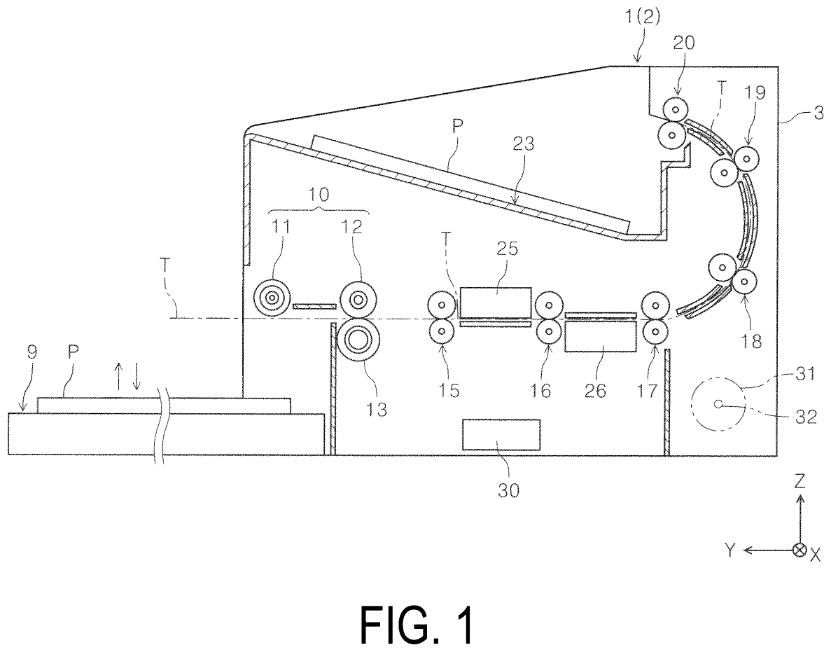

As illustrated in FIG. 1, the image reading apparatus 1 includes a transport path T for transporting a medium. The transport path T is formed inside a device main body 3. In FIG. 1, the transport path T is indicated with the one-dot chain line. In the transport path T, a medium P is transported linearly along the −Y direction, then is inverted upward, and is discharged in the +Y direction.

Hereinafter, the configuration of the transport path T is described along the direction in which the medium is transported. Note that, hereinafter, a direction in which the medium is transported may be referred to as “downstream”, and a direction opposite thereto may be referred to as “upstream”.

At the most upstream position in the transport path T, a medium support section 9 that supports a medium is provided. The medium support section 9 supports a medium horizontally. As a matter of course, the medium support section 9 may support a medium in an inclined posture. The reference symbol P indicates a medium supported by the medium support section 9. Hereinafter, the medium is denoted with the symbol P, and is referred to as the medium P.

The medium support section 9 moves upward and downward along the vertical direction while maintaining a posture by a driving source, which is omitted in illustration. When the medium support section 9 moves upward, the medium P supported by the medium support section 9 can contact with a pick roller 11.

The pick roller 11 is driven by a motor 31 being an example of a driving source, and sends out the medium P, which is supported by the medium support section 9, downstream.

A feeding roller 12 is provided downstream of the pick roller 11 in the transport path T. The feeding roller 12 is driven by the motor 31, and feeds the medium P downstream.

The pick roller 11 and the feeding roller 12 configure a feeding section 10 that feeds the medium P from the medium support section 9. The feeding section 10 is driven by the motor 31 being an example of a driving source.

A separation roller 13 is provided at a position facing the feeding roller 12. The separation roller 13 separates the medium P by nipping the medium P with the feeding roller 12. The separation roller 13 is driven by a motor, which is omitted in illustration, in a direction of returning the medium P upstream. In a driving force transmission path between the separation roller 13 and the motor, which is omitted in illustration, a torque limiter, which is omitted in illustration is interposed. When only one medium P is present between the feeding roller 12 and the separation roller 13, the separation roller 13 is driven to rotate while contacting with the medium P due to an operation of the torque limiter. When a plurality of media P are present between the feeding roller 12 and the separation roller 13, the separation roller 13 is driven by a driving force of the motor, which is omitted in illustration, to rotate in the direction of returning the medium P upstream. With this, overlap feeding is prevented.

Note that a separation pad may be employed in place of the separation roller 13.

The pick roller 11, the feeding roller 12, and the separation roller 13, which are described above, are provided at a center position in the medium width direction.

Next, at a position downstream of the feeding roller 12 in the transport path T, a first transport roller pair 15, a second transport roller pair 16, and a third transport roller pair 17 are provided in the stated order toward downstream. A segment from the pick roller 11 to the third transport roller pair 17 in the transport path T extends horizontally.

At least one roller in each of the first transport roller pair 15, the second transport roller pair 16, and the third transport roller pair 17 is driven by the motor 31. The first transport roller pair 15, the second transport roller pair 16, and the third transport roller pair 17 transport the medium P downstream.

Between the first transport roller pair 15 and the second transport roller pair 16, the first reading section 25 is provided on the upper side with respect to the transport path T. Further, between the second transport roller pair 16 and the third transport roller pair 17, the second reading section 26 is provided on the lower side with respect to the transport path T.

The first reading section 25 reads an image on a first surface of the medium P. The second reading section 26 reads an image on a second surface of the medium P, which is opposite to the first surface.

As an example, the first reading section 25 and the second reading section 26 are each configured to include a contact image sensor (CIS).

The transport path T is curved upward at a position downstream of the third transport roller pair 17, and is inverted. In this segment that is curved and inverted, a fourth transport roller pair 18, a fifth transport roller pair 19, and a sixth transport roller pair 20 are provided in the stated order toward downstream. At least one roller in each of the fourth transport roller pair 18, the fifth transport roller pair 19, and the sixth transport roller pair 20 is driven by the motor 31. The fourth transport roller pair 18 and the fifth transport roller pair 19 transport the medium P downstream. The sixth transport roller pair 20 discharges the medium P in the +Y direction.

The medium P discharged by the sixth transport roller pair 20 supports a discharge reception section 23. The discharge reception section 23 supports the medium P in an inclined posture. As a matter of course, the discharge reception section 23 may support the medium P in a horizontal posture.

A control section 30 controls a series of operations such as an upward/downward movement operation of the medium support section 9, a rotation operation of each of the rollers, and reading of an image on the medium P by the first reading section 25 and the second reading section 26. The control section 30 includes a CPU, a non-volatile memory, and the like, which are omitted in illustration. A program, a parameter, and the like for executing various types of control are stored in a non-volatile memory.

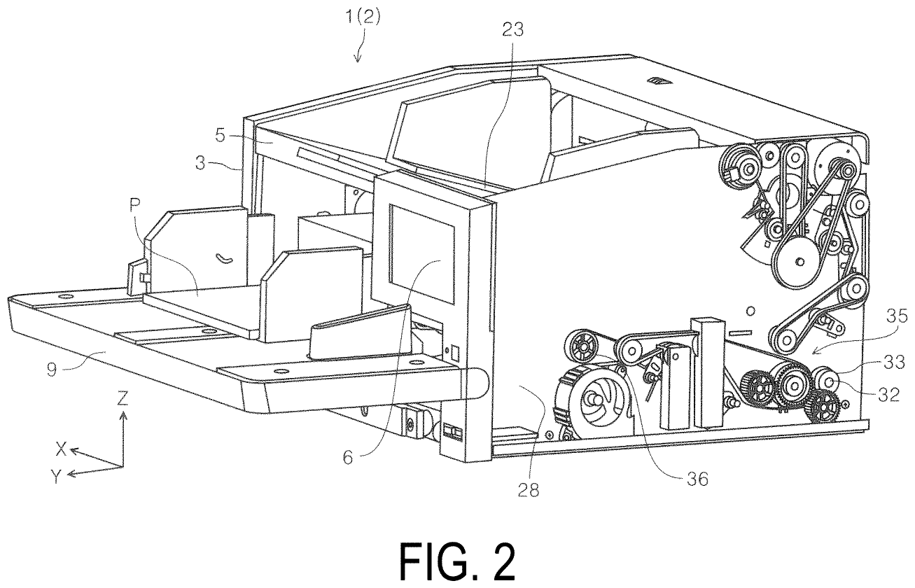

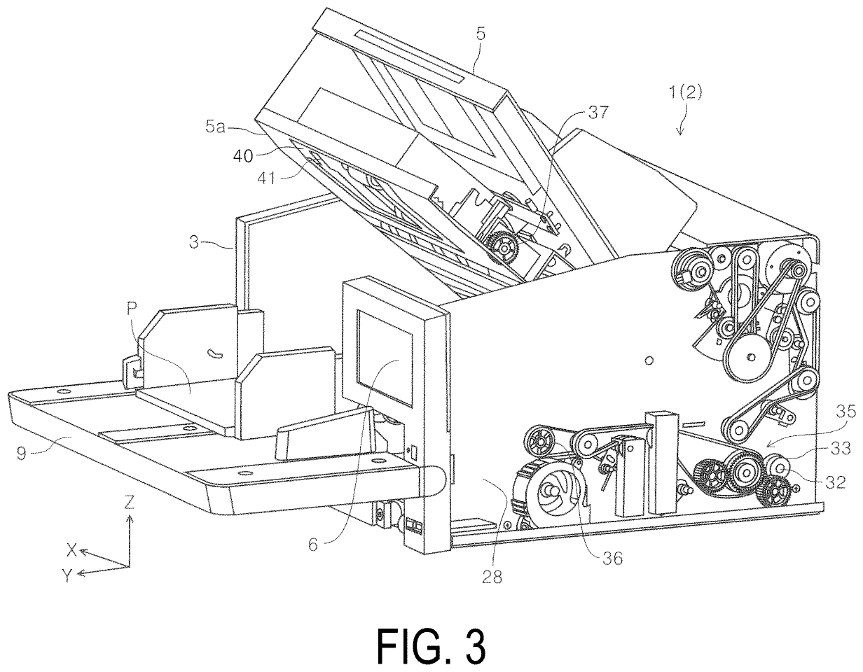

Next, as illustrated in FIG. 2 and FIG. 3, the device main body 3 is provided with an opening/closing unit 5 in an openable/closable manner. The opening/closing unit 5 is opened and closed by rotating about a rotary shaft, which is omitted in illustration, as a center. In a closed state illustrated in FIG. 2, the opening/closing unit 5 forms a part of the transport path T. Further, in an opened state illustrated in FIG. 3, the opening/closing unit 5 releases a part of the transport path T.

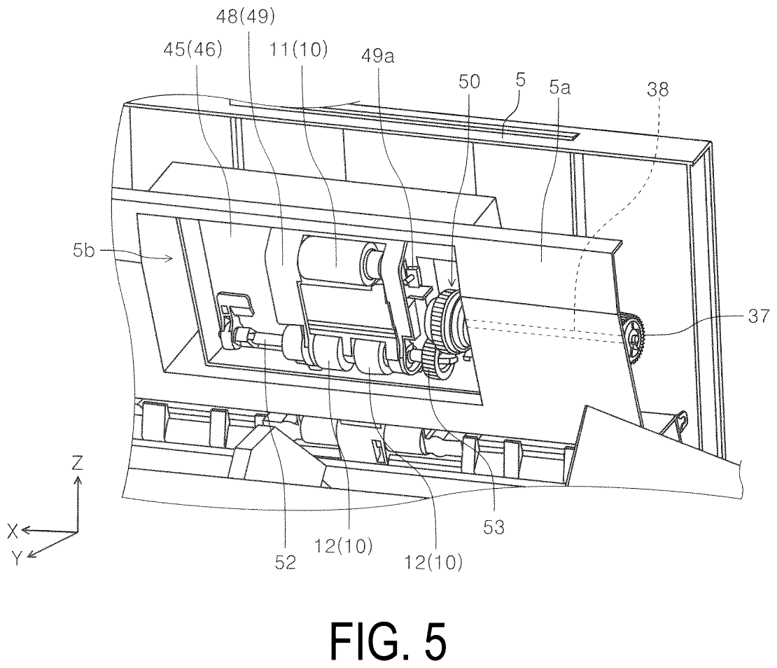

In particular, the opening/closing unit 5 is provided with the pick roller 11 and the feeding roller 12. The opening/closing unit 5 includes a unit mounting section 5a, and the unit mounting section 5a is provided with a feeding unit 45 (see FIG. 5). Details thereof are described later. The pick roller 11 and the feeding roller 12 are provided to the feeding unit 45.

In the configuration described above, when the opening/closing unit 5 is opened, the feeding roller 12 is separated from the separation roller 13.

Note that the device main body 3 is provided with a display section 6 that displays various types of information and receives various operation settings. As an example, the display section 6 is configured by a touch panel.

A frame 28 configuring the base body of the device main body 3 is provided with a driving force transmission mechanism 35. In FIG. 2 and FIG. 3, the reference symbol 32 indicates a driving shaft of the motor 31. The driving shaft 32 is provided with a driving toothed gear 33. The driving force transmission mechanism 35 obtains a driving force from the driving toothed gear 33. The driving force transmission mechanism 35 transmits a driving force of the motor 31 to a pulley 36.

In the +X direction, that is, on the inner side of the device main body 3 with respect to the frame 28, a toothed gear rotating coaxially with the pulley 36, which is omitted in illustration, is provided. When the opening/closing unit 5 is closed, this toothed gear is meshed with a toothed gear 37 provided to the opening/closing unit 5, and transmits a driving force to the toothed gear 37. Note that, when the opening/closing unit 5 is opened, the toothed gear 37 provided to the opening/closing unit 5 is separated from the toothed gear described above, which is omitted in illustration.

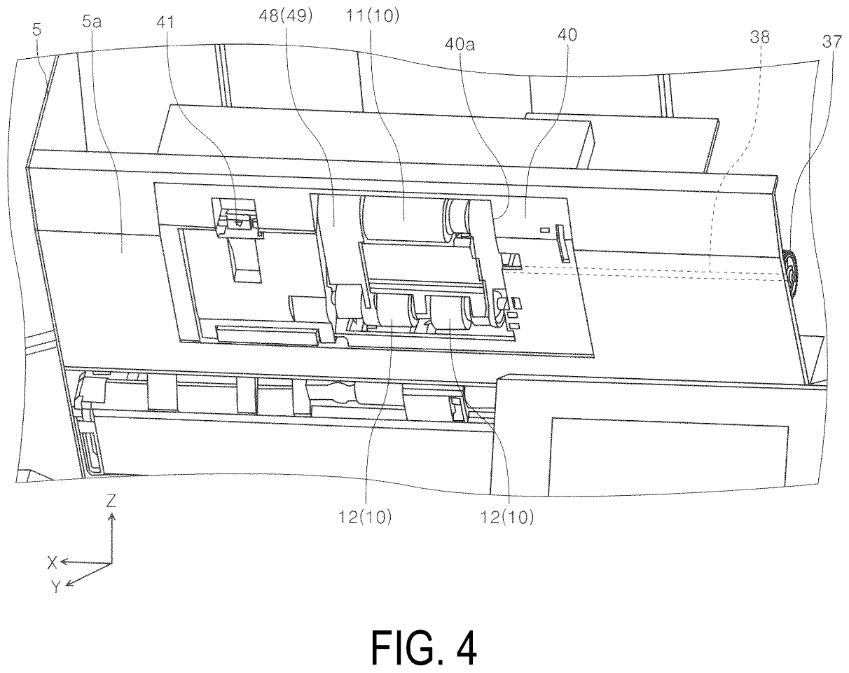

As illustrated in FIG. 4, the toothed gear 37 is provided to a driving shaft 38. The driving shaft 38 is axially supported by a bearing portion, which is omitted in illustration. The bearing portion is provided to the unit mounting section 5a configuring opening/closing unit 5.

The unit mounting section 5a is provided with a cover 40. The cover 40 can be removed by pulling an operation lever 41. The cover 40 includes a locking portion (omitted in illustration) that can be engaged with an engaging portion provided to the unit mounting section 5a, which is omitted in illustration. Locking of the cover 40 by the locking portion can be canceled by pulling the operation lever 41. Note that the cover 40 may be removably mounted on the unit mounting section 5a in a snap-fit manner.

Further, instead of a configuration in which the cover 40 is removably mounted on the unit mounting section 5a, the cover 40 may be configured to be openable and closable with respect to the unit mounting section 5a.

An opening 40a is formed in the cover 40. The feeding section 10, in other words, the pick roller 11 and the feeding roller 12 are exposed through the opening 40a. The pick roller 11 and the feeding roller 12 configure a roller unit 48. The opening 40a exposes a part of the roller unit 48.

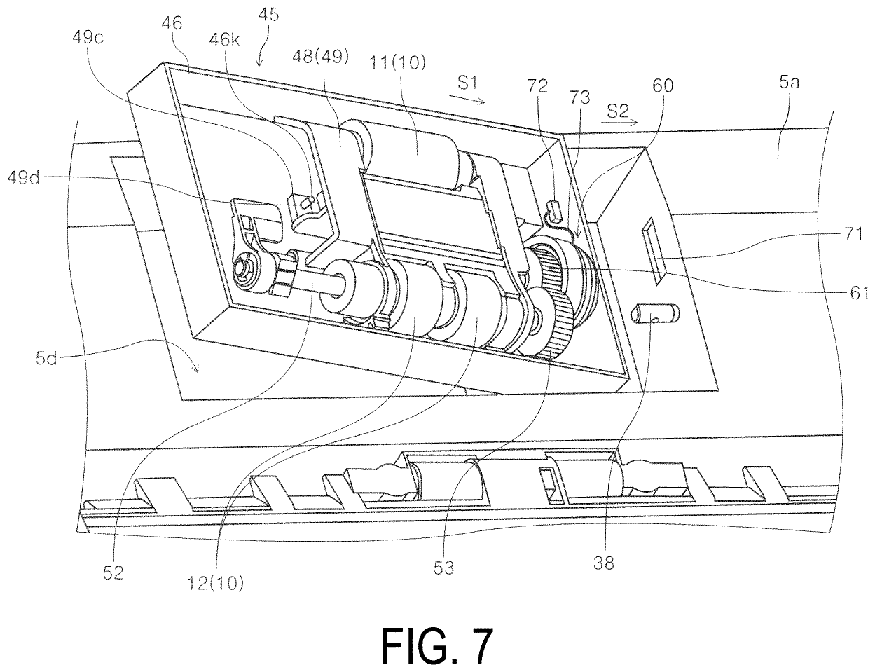

As illustrated in FIG. 5, when the cover 40 is removed, the feeding unit 45 is exposed, and the feeding unit 45 can be removably mounted thereto. The feeding unit 45 is accommodated in a recessed portion 5b provided in the unit mounting section 5a. The feeding unit 45 is inserted obliquely with respect to the recessed portion 5b as indicated with the arrow S1 in FIG. 7, and then slides in a direction parallel to the bottom surface of the recessed portion 5b as indicated with the arrow S2. In this manner, the feeding unit 45 can be mounted. The feeding unit 45 can be removed from the recessed portion 5b in a reverse manner. The feeding unit 45 slides in a direction opposite to the direction indicated with the arrow S2, and then, is drawn out in a direction opposite to the direction indicated with the arrow S1.

Note that the feeding unit 45 can slide in the X-axis direction within the recessed portion 5b. However, a dimensional relationship between the recessed portion 5b and an accommodation member 46, which is described later, is set so that the feeding unit 45 is prevented from moving in the Y-axis direction.

Note that the feeding unit 45 is held with respect to the unit mounting section 5a by mounting the cover 40 thereto. However, the feeding unit 45 may be held with respect to the unit mounting section 5a by a snap-fit structure, a screw fixing structure, or the like. In other words, a means for holding the feeding unit 45 with respect to the unit mounting section 5a is not particularly limited as long as the feeding unit 45 is removably mounted on the unit mounting section 5a.

A base body of the feeding unit 45 is the accommodation member 46. The accommodation member 46 is formed into a tray-like shape. The feeding unit 45 includes the roller unit 48 and a switching section 60 in a removable manner inside the accommodation member 46.

A base body of the roller unit 48 is a base member 49. The pick roller 11 and the feeding roller 12 are rotatably provided to the base member 49. Note that the base member 49 is provided with a driving force transmission mechanism (omitted in illustration) that transmits a driving force from a rotary shaft 52 of the feeding roller 12 to the pick roller 11. The driving force transmission mechanism can be configured by a plurality of toothed gears.

Note that at least one of the pick roller 11 or the feeding roller 12, or both of them may be configured to be removably mounted on the base member 49. For example, when the feeding roller 12 is configured to be removably mounted on the base member 49, the base member 49 may be provided to a bearing portion that can be fitted with the rotary shaft 52 of the feeding roller 12 in a snap manner. This similarly applies to the configuration of removably mounting the pick roller 11 to the base member 49.

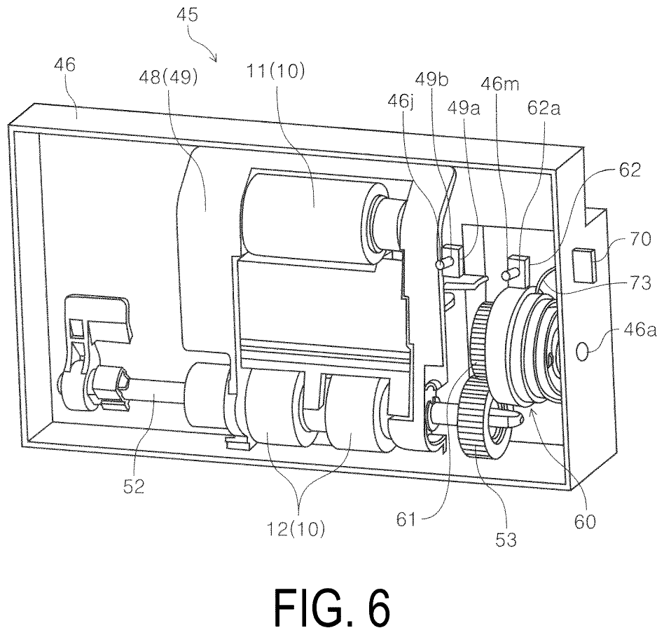

The base member 49 is provided with an attachment portion 49a (see FIG. 5 and FIG. 6), and a fitting hole 49b is formed in the attachment portion 49a. Further, the base member 49 is provided with an attachment portion 49c (see FIG. 7), and a fitting hole 49d is formed in the attachment portion 49c.

In the accommodation member 46, a boss 46j is formed as illustrated in FIG. 6, and a boss 46k is formed as illustrated in FIG. 7.

The boss 46j can be fitted into the fitting hole 49b. Further, the boss 46k can be fitted into the fitting hole 49d. There is provided a configuration in which a constant frictional force is generated between the boss 46j and the fitting hole 49b and between the boss 46k and the fitting hole 49d. With this, the roller unit 48 can be held with respect to the accommodation member 46.

When the roller unit 48 is held by the frictional force described above, the following matters are achieved. First, in the process of opening the opening/closing unit 5 from the completely closed state (FIG. 2) to the fully opened state (FIG. 3), the roller unit 48 does not come off from the accommodation member 46 regardless of presence or absence of mounting of the cover 40. Second, in the process of closing the opening/closing unit 5 from the fully opened state (FIG. 3) to the completely closed state (FIG. 2), the roller unit 48 does not come off from the accommodation member 46 regardless of presence or absence of mounting of the cover 40. Third, the roller unit 48 can be removed from the accommodation member 46.

Note that, when the opening/closing unit 5 is in the completely closed state, fitting between the boss 46j and the fitting hole 49b and fitting between the boss 46k and the fitting hole 49d regulate the positions of the pick roller 11 and the feeding roller 12 in the horizontal direction.

Note that the end of the boss 46j is configured to be larger than the diameter of the fitting hole 49b and to expand and contract elastically. With this, the attachment portion 49a can be removably mounted on the accommodation member 46 in a snap-fit manner. Similarly, the end of the boss 46k is configured to be larger than the diameter of the fitting hole 49d and to expand and contract elastically. With this, the attachment portion 49c can be removably mounted on the accommodation member 46 in a snap-fit manner.

Moreover, the attachment portion 49a, 49c may be configured to be fixed with respect to the accommodation member 46 by a screw, which is omitted in illustration.

In other words, any means may be selected as a means for holding the roller unit 48 with respect to the feeding unit 45 as long as the roller unit 48 is removably mounted on the feeding unit 45.

Next, the switching section 60 is described. The switching section 60 may be in a state of being engaged with the driving shaft 38 and a state of being away from the driving shaft 38. When the feeding unit 45 is mounted on the unit mounting section 5a, the switching section 60 and the driving shaft 38 are engaged with each other. When the feeding unit 45 is removed from the unit mounting section 5a, the switching section 60 is away from the driving shaft 38.

In the present embodiment, the switching section 60 is an electro-magnetic clutch. The switching section 60 is capable of performing switching between a state in which rotation of the driving shaft 38 is transmitted to the rotary shaft 52 and a state in which rotation of the driving shaft 38 is not transmitted to the rotary shaft 52, according to control of the control section 30 (see FIG. 1).

The switching section 60 is provided with a toothed gear 61. The toothed gear 61 is meshed with a toothed gear 53 provided to the rotary shaft 52, and transmits a driving force to the toothed gear 53. With this, a driving force of the motor 31 (see FIG. 1) is transmitted to the feeding roller 12 and the pick roller 11.

Note that, when the switching section 60 is removed from the feeding unit 45, meshing between the toothed gear 61 and the toothed gear 53 is canceled.

As illustrated in FIG. 6, a shaft hole 46a is formed in the accommodation member 46. As illustrated in FIG. 7, one end of the driving shaft 38 protrudes in the recessed portion 5b of the unit mounting section 5a. When the feeding unit 45 is mounted on the unit mounting section 5a, the driving shaft 38 enters the shaft hole 46a of the accommodation member 46. Further, the driving shaft 38 is fitted into a fitting hole of the switching section 60, which is omitted in illustration. With this, a state in which a driving force of the motor 31 (see FIG. 1) is transmitted from the driving shaft 38 to the switching section 60 is achieved. Further, when the driving shaft 38 enters the shaft hole 46a of the accommodation member 46, the driving shaft 38 is in a state of holding the feeding unit 45 so as to prevent the feeding unit 45 from coming off from the recessed portion 5b.

When the feeding unit 45 is removed from the unit mounting section 5a, the driving shaft 38 comes out of the shaft hole 46a, and a state in which the driving shaft 38 and the switching section 60 are away from each other is achieved.

A cable 73 extends from the switching section 60, and the cable 73 is provided with an inner connector 72. Further, on the outer side of the accommodation member 46, an outer connector 70 is provided as illustrated in FIG. 6. The inner connector 72 can be coupled to the outer connector 70 on the inner side of the accommodation member 46.

The recessed portion 5b of the unit mounting section 5a is provided with a coupling section 71 as illustrated in FIG. 7. When the feeding unit 45 is mounted on the unit mounting section 5a, the outer connector 70 can be coupled to the coupling section 71. With this, electrical coupling between the switching section 60 and the control section 30 (see FIG. 1) is established, and the switching section 60 can be controlled by the control section 30. Note that, when the feeding unit 45 is removed from the unit mounting section 5a, coupling between the outer connector 70 and the coupling section 71 is canceled.

As illustrated in FIG. 6, the switching section 60 is provided with an attachment portion 62. A fitting hole 62a is formed in the attachment portion 62. A boss 46m is formed in the accommodation member 46.

The boss 46m can be fitted into the fitting hole 62a. There is provided a configuration in which a constant frictional force is generated between the boss 46m and the fitting hole 62a. With this, the switching section 60 can be held with respect to the accommodation member 46.

When the switching section 60 is held by the frictional force described above, the following matters are achieved. Firstly, in the fully opened state (FIG. 3) of the opening/closing unit 5, when the feeding unit 45 is mounted on the unit mounting section 5a, the switching section 60 does not come off from the accommodation member 46. Secondly, in the fully opened state (FIG. 3) of the opening/closing unit 5, when the feeding unit 45 is removed from the unit mounting section 5a, the switching section 60 does not come off from the accommodation member 46. Thirdly, the switching section 60 can be removed from the accommodation member 46.

Note that the end of the boss 46m is configured to be larger than the diameter of the fitting hole 62a and to expand and contract elastically. With this, the attachment portion 62 can be removably mounted on the accommodation member 46 in a snap-fit manner.

Moreover, the attachment portion 62 may be configured to be fixed with respect to the accommodation member 46 by a screw, which is omitted in illustration.

In other words, any means may be selected as a means for holding the switching section 60 with respect to the feeding unit 45 as long as the switching section 60 is removably mounted on the feeding unit 45.

Note that the inner connector 72 is removed from the outer connector 70 to remove the switching section 60 from the feeding unit 45.

As described above, the image reading apparatus 1 or the medium feeding device 2 includes the switching section 60 capable of performing switching between a state in which a driving force is transmitted from the motor 31 being an example of a driving source (see FIG. 1) to the feeding section 10 and a state in which a driving force is not transmitted. Further, the image reading apparatus 1 or the medium feeding device 2 includes the feeding unit 45 being a removably unit including the feeding section 10 and the switching section 60 and the unit mounting section 5a to which the feeding unit 45 is mounted. Further, the switching section 60 is removably mounted on the feeding unit 45.

With this, when there is a need for replacement of the switching section 60, maintenance, or the like, such work can easily be executed. In particular, the feeding unit 45 is removed from the unit mounting section 5a, and then the switching section 60 is removed from the feeding unit 45. With this, the switching section 60 can be removed with further facilitated workability.

Note that, in the present embodiment, the switching section 60 is, but not limited to, an electro-magnetic clutch, and may be configured as long as switching between a state in which a driving force is transmitted from the motor 31 (see FIG. 1) to the feeding section 10 and a state in which a driving force is not transmitted can be performed. For example, the switching section 60 may be configured by a toothed gear device including a toothed gear displaced by an operation of a solenoid and being capable of performing switching between a state in which meshing is generated and a state in which meshing is canceled by displacement of the toothed gear.

Further, in the present embodiment, the feeding unit 45 includes the accommodation member 46 that accommodates the feeding section 10 and the switching section 60. Further, the switching section 60 is removably mounted on the accommodation member 46. With this, handling of the feeding unit 45 is facilitated.

Note that, for example, the switching section 60 may be configured to be removably mounted on the roller unit 48 without using the accommodation member 46.

Further, in the present embodiment, the feeding section 10 includes the pick roller 11 and the feeding roller 12 that is positioned downstream of the pick roller 11 in the medium feeding direction and feeds the medium further downstream. Further, the roller unit 48 including the pick roller 11 and the feeding roller 12 is removably mounted on the feeding unit 45. With this, when there is a need for replacement of the feeding section 10, maintenance, or the like, such work can easily be executed. In particular, the feeding unit 45 is removed from the unit mounting section 5a, and then the roller unit 48 is removed from the feeding unit 45. With this, the roller unit 48 can be removed with further facilitated workability.

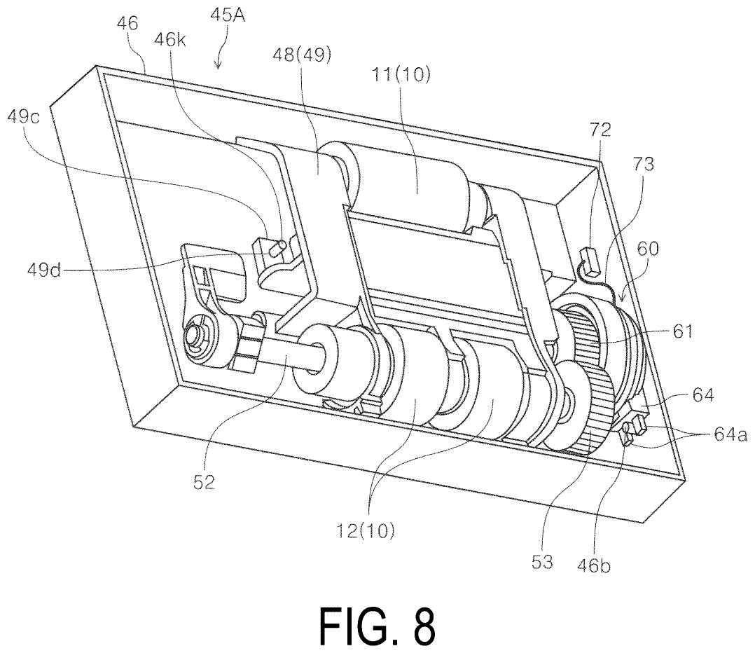

Next, with reference to FIG. 8, another embodiment is described. Note that, hereinafter, the same components as those already described are denoted with the same reference symbols, and redundant description thereof is omitted below. Further, when the embodiment described hereinafter includes a configuration similar to that of the embodiment described above, it is assumed that the operational effects similar to those in the embodiment described above are exerted as long as technical contradictions are caused.

In a feeding unit 45A illustrated in FIG. 8, the switching section 60 is provided with an attachment portion 64. A boss 46b is formed at the accommodation member 46 so that the boss 46b protrudes inward.

A nipping portion 64a that nips the boss 46b is formed at the attachment portion 64. When the nipping portion 64a nips the boss 46b, the switching section 60 can be held with respect to the accommodation member 46.

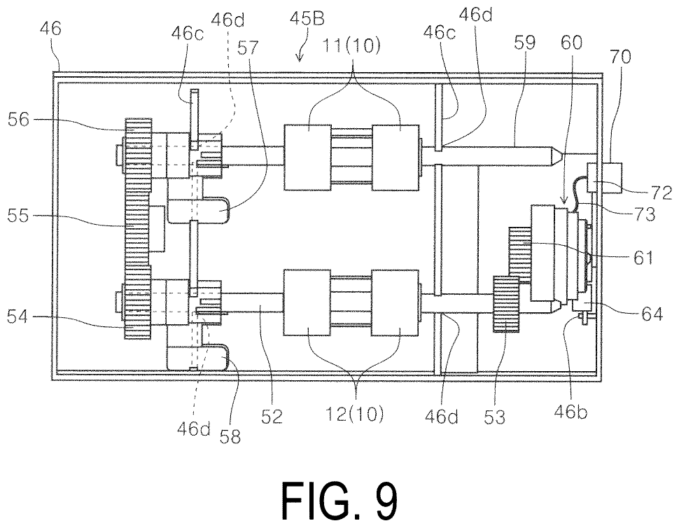

Next, with reference to FIG. 9, another embodiment is further described. In a feeding unit 45B illustrated in FIG. 9, each of the pick roller 11 and the feeding roller 12 is configured to be removably mounted on the accommodation member 46.

Specifically, two wall portions 46c are formed at the accommodation member 46. The wall portions 46c extend in a direction intersecting with the rotary shafts 52 and 59. The wall portions 46c are provided at an interval along the axial directions of the rotary shafts 52 and 59. Note that the rotary shaft 59 is a rotary shaft of the pick roller 11.

Fitting portions 46d into which the rotary shafts 52 and 59 are fitted in a snap-fit manner are formed in the wall portions 46c. The rotary shafts 52 and 59 are removably mounted with respect to the fitting portions 46d, and are rotatably supported by the fitting portions 46d while being mounted.

Note that a lever portion 58 is provided to the rotary shaft 52, and the rotary shaft 52 can easily be removed by holding the lever portion 58. Further, the rotary shaft 59 is provided with a lever portion 57, and the rotary shaft 59 can easily be removed by holding the lever portion 57.

Note that the rotary shaft 52 is provided with a toothed gear 54. The toothed gear 54 is meshed with a toothed gear 55. Further, the rotary shaft 59 is provided with a toothed gear 56. The toothed gear 56 is meshed with the toothed gear 55. With this, a driving force is transmitted from the rotary shaft 52 to the pick roller 11.

As described above, each of the pick roller 11 and the feeding roller 12 is configured to be removably mounted on the roller unit 48. With this, only one of the pick roller 11 or the feeding roller 12 can be replaced, and usability of the device is improved.

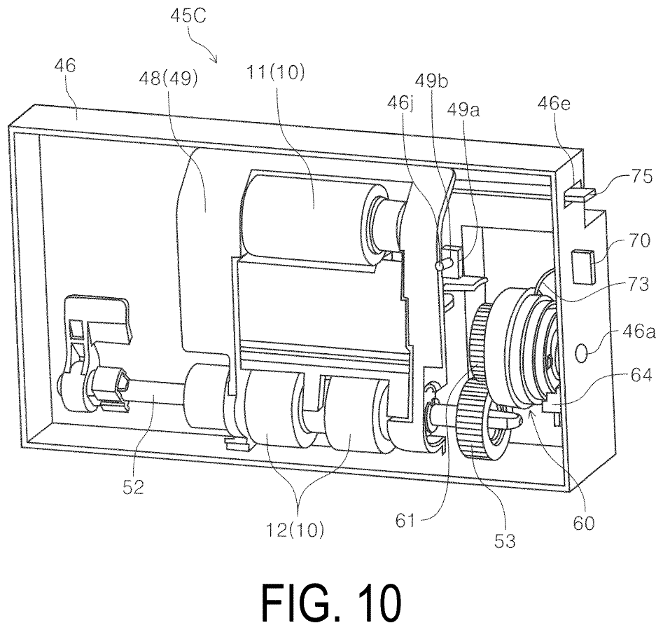

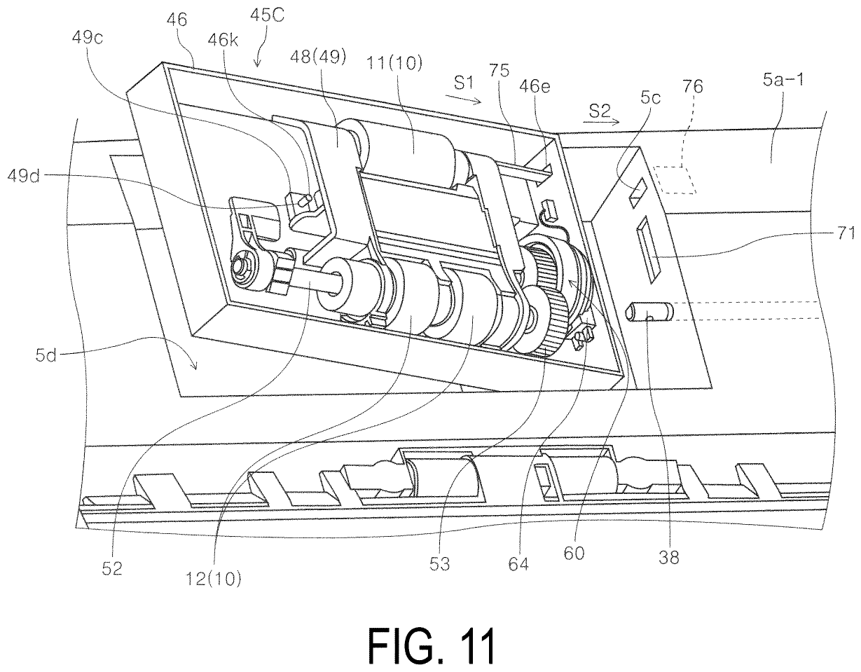

Next, with reference to FIG. 10 and FIG. 11, another embodiment is further described. In FIG. 10, and FIG. 11, the roller unit 48 is provided with a detected section 75. The detected section 75 is provided to the base member 49 configuring the base body of the roller unit 48. The detected section 75 has a shape protruding in a mounting direction of a feeding unit 45C.

An opening 46e is formed in the accommodation member 46. When the roller unit 48 is mounted with respect to the accommodation member 46, the detected section 75 protrudes from the opening 46e to the outer side of the accommodation member 46. Note that, when the roller unit 48 is not mounted on the accommodation member 46, the detected section 75 does not protrude from the opening 46e to the outer side of the accommodation member 46.

As illustrated in FIG. 11, an opening 5c is formed in a unit mounting section 5a-1. A detecting section 76 on the inner side of the opening 5c. The feeding unit 45C in a state in which the detected section 75 protrudes to the outer side of the accommodation member 46 is mounted on the unit mounting section 5a-1. With this, the detected section 75 can enter the opening 5c. Further, with this, the detecting section 76 can detect the detected section 75. The detecting section 76 may be an optical sensor where an optical axis of detection light is blocked by the detected section 75, or may be a contact sensor that is pressed by the detected section 75.

Further, the control section 30 (see FIG. 1) can detect that the feeding unit 45C is mounted, based on detection information from the detecting section 76, and can detect that the roller unit 48 is mounted on the feeding unit 45C being mounted.

In this manner, the unit mounting section 5a-1 includes the detecting section 76 capable of detecting the detected section 75 when the feeding unit 45C is mounted. With this, it can be detected that the feeding unit 45C is mounted while the roller unit 48 is forgotten to be mounted on the feeding unit 45C. As a result, the medium can be fed as appropriate.

Note that, in addition to providing the roller unit 48 with the detected section 75, the switching section 60 may be provided with the detected section 75. With this, it can be detected that the feeding unit 45C is mounted while the switching section 60 is forgotten to be mounted on the feeding unit 45C.

Alternatively, in addition to providing the roller unit 48 with the detected section 75, the switching section 60 may be provided with a detected section similar to the detected section 75 described above, and the unit mounting section 5a-1 may be provided with a detecting section similar to the detecting section 76 described above. With this, non-mounting of both the roller unit 48 and the switching section 60 can be detected.

Note that, when a feeding instruction is received while the detected section 75 is not detected, the control section 30 (see FIG. 1) may suspend feeding of a medium and display an alert indicating the situation on the display section 6 (see FIG. 2), based on detection information from the detecting section 76. With this, a user can be notified that the switching section 60 or the roller unit 48 is not mounted. As a result, usability of the device is improved.

It is needless to say that the present disclosure is not limited to the embodiments or modification examples described above, and various modifications can be made within the scope of the present disclosure as described in the claims, which also fall within the scope of the present disclosure.

What is claimed is:

1. A medium feeding device configured to feed a medium, comprising:
a medium support section configured to support a medium;
a feeding section configured to feed a medium from the medium support section;
a driving power source for the feeding section;
a switching section configured to perform switching between a state in which a driving force is transmitted from the driving power source to the feeding section and a state in which a driving force is not transmitted; and
a feeding unit being a unit configured to accommodate the feeding section and the switching section and being removably mounted on a unit mounting section, wherein
the switching section is removably mounted on the feeding unit.

2. A medium feeding device according to claim 1, wherein
the feeding unit includes an accommodation member configured to accommodate the feeding section and the switching section, and
the switching section is removably mounted on the accommodation member.

3. A medium feeding device according to claim 2, wherein
the feeding section includes:
a pick roller configured to send out a medium from the medium support section; and
a feeding roller being positioned downstream in a medium feeding direction with respect to the pick roller and being configured to further feed a medium further downstream, and
a roller unit including the pick roller and the feeding roller is removably mounted on the feeding unit.

4. A medium feeding device according to claim 3, wherein
each of the pick roller and the feeding roller is removably mounted on the roller unit.

5. A medium feeding device according to claim 3, wherein
at least one of the switching section or the roller unit is provided with a detected section, and
the unit mounting section includes a detecting section configured to detect the detected section when the feeding unit is mounted.

6. A medium feeding device according to claim 5, comprising:
a display section configured to display various types of information; and
a control section configured to receive detection information from the detecting section and control the display section, wherein
the control section suspends feeding of a medium and displays an alert on the display section when a feeding instruction is received while the detected section is not detected, based on detection information from the detecting section.

7. A medium feeding device according to claim 3, comprising:
a device main body including the driving power source; and
an opening/closing unit being a unit configured to be opened and closed with respect to the device main body, the opening/closing unit forming a part of a transport path for transporting a medium while by being closed, and releasing a part of the transport path by being opened, wherein
the unit mounting section is provided to the opening/closing unit, and
the device main body includes a separation roller configured to nip a medium with the feeding roller and separate the medium.

8. An image reading apparatus comprising:
the medium feeding device according to claim 1; and
a reading unit configured to read a medium fed by the medium feeding device.
